(19) United States
(12) Patent Application Publication
(10) Pub. No.: US 2008/0023169 A1
(43) Pub. Date: Jan. 31, 2008

(54) Forming fabric with extended surface

(76) Inventors: Lippi A. Fernandes, Overijssel (NL); Martin Ringer, Lancashire (GB); Anthony Morton, Yorkshire (GB); John Jeffery, Lancashire (GB); Justin Payne, Lancashire (GB)

Correspondence Address: VOITH FABRICS, 3040 BLACK CREEK ROAD, P.O. BOX 1411, WILSON, NC, 27893, US

(21) Appl. No.: 11/486,783

(22) Filed: Jul. 14, 2006

(51) Int. Cl. D21F 3/00; B32B 5/02

(52) U.S. Cl. 162/358.2; 442/59

(57) ABSTRACT

A fabric for an advanced dewatering system having a woven fabric, the woven fabric having a paper side and a roll side. The paper side has a paper side surface and the roll side has a roll side surface; and a polymer material is deposited onto the fabric that extends above the paper side surface. The polymer material has at least one of a random pattern, a random motif, a pseudo-random pattern, a pseudo-random motif, a predetermined pattern, and a predetermined motif.

### CROSS-REFERENCE TO RELATED APPLICATIONS

Not Applicable.

### STATEMENT REGARDING FEDERALLY SPONSORED RESEARCH OR DEVELOPMENT

Not applicable.

### REFERENCE TO A COMPACT DISK APPENDIX

Not applicable.

### BACKGROUND OF THE INVENTION

1. Field of the Invention

The invention relates to a fabric used in papermaking. More specifically, the present invention relates to forming fabrics used in the forming section of a papermaking machine, and more specifically, to a forming fabric for use in tissue making.

2. Description of Background

In the art of papermaking, multiple steps occur from the introduction of a pulp slurry to the output of a finished paper product. The initial introduction of the slurry is at the portion of a papermaking machine known as the wet end. Here, the slurry, or fiber suspension, is initially dewatered when the slurry is introduced onto a moving forming fabric, in the forming section of the papermaking machine. Varying amounts of water is removed from the slurry through the forming fabric, resulting in the formation of a fibrous web on the surface of the forming fabric.

Forming fabrics address not only the dewatering of the slurry, but also the sheet formation, and therefore the sheet quality, resulting from the formation of the fibrous web. More specifically, the forming fabric must simultaneously control the rate of drainage while preventing fiber and other solid components contained in the slurry from passing through the fabric with the water. The role of the forming fabric also includes conveyance of the fibrous web to the press section of the papermaking machine.

Additionally, if drainage of water from the slurry occurs to rapidly or too slowly, the quality of the fibrous web is reduced, and overall machine production efficiency is reduced. Controlling drainage by way of fabric void volume is one of the fabric design criteria.

Forming fabrics have been produced to meet the needs and requirements of the various papermaking machines for the various paper grades being manufactured. As the needs arises to increase production speed of the papermaking machines and the quality of the paper being produced, the need for improved paper machine clothing allowing for increase production rates and improved quality resulted.

In tissue making, it is known to add texture or patterns to the fibrous web during manufacturing. In WO 02/088464 it is known to pattern paper for use in a tissue for beverage infusion, that is, a tea bag. Here a screen, or forming fabric, is used for producing paper by a wet-laying technique. The screen has a base material woven in a mesh-like structure, preferably with synthetic monofilaments. Drainage blockage of the base material is accomplished by applying a synthetic resin to block apertures of the base fabric mesh. The pattern or letters are formed by laying down a polymer that provide complete or partial blockage of discrete apertures. In this manner the polymer does not affect the surface properties of the woven fabric as the polymer fills discrete apertures of the fabric mesh. A pattern is formed when the water of the fibrous suspension drains through regions of the fabric that are not blocked. The result is a paper product with higher fiber concentration corresponding to unblocked areas as compared to blocked areas. In this manner, a pattern is formed where there is lower fiber concentration. This results in a weakness of the fibrous web in the areas of lower fiber concentration.

While printed forming fabrics can be used on conventional tissue machines, there is no advantage by using them on conventional tissue machines, were the sheet is 100% pressed and the bulk is too low to produce micro-embossed and macro-embossed sheet in the machine and a converting line to emboss the sheet is needed. The printed forming fabric can be used on through air drying machines (TAD) were the bulk and sheet absorbency is 50 to 100% higher then on conventional machines. On this kind of machine the sheet is formed on a twin wire, sheet is vacuum dewatered to a dryness between 22 and 26% and only at this high consistency, the sheet is transferred to a molding fabric (structured fabric), where it is wet molded, by a vacuum box (wet shaping box), which is suctioning the fibers into the valleys of the structured fabric. By suctioning an already formed sheet, with over 20% consistency, the fibers are stretched into the valleys, thus the sheet caliper is reduced and only a small portion of the fibers remain protected within the structure of the fabric, which are the fibers which will be remain unpressed for quality. Thus on TAD machines, there is a need to run a negative draw between the forming section and the TAD section. Generally TAD machines run 20% lower speed on the TAD section to brush the fibers into the valleys of the fabric. In this manner, all the macro embossing (drawings) coming from the printed forming fabric will be destroyed by the speed difference between forming section and TAD section. Accordingly, on TAD machines the macro and micro-embossing has to be done with the structured fabric in the TAD section and not in the forming section. By doing this micro and macro embossing in the machine it would be possible to avoid doing it in the converting line, thus compacting the sheet and loosing quality.

Accordingly, there is a need for a fabric that forms a web having texture and more uniform fiber concentrations for improved marking and overall performance.

### BRIEF SUMMARY OF THE INVENTION

Accordingly, the present invention is for a fabric used in papermaking, and more particularly, as a forming fabric for manufacturing a web for tissue in an advanced dewatering system. In the preferred embodiment, the fabric is a forming fabric having a polymeric deposit. The fabric may be any known forming fabric, for example, single or multi layer.

Additionally, the present invention is for a forming fabric that produces a structured sheet in the Advanced Dewatering System (ADS, also known as Advanced Tissue Molding System, or ATMOS) machine, which produces the same quality, bulk and water absorbency as TAD machines and do the micro-embossing with the molding fabric and the macro-embossing with the special developed forming fabric. Since the produced sheet is already wet structured in the machine, there is no need to further emboss the sheet going through an expensive converting line to press the micro and macro structures into the sheet. By pressing the structure into the dry sheet, on a converting line, the sheet is compacted, thus the quality, bulk, volume and absorbency capacity are reduced. In ATMOS, the speed of the paper stays approximately the same during fabric transfer.

On an ADS, the sheet is formed and dewatered between the molding fabric and a forming fabric, and the sheet is further dewatered between the molding fabric and a dewatering fabric. The sheet is dewatered through the dewatering fabric (opposite to molding fabric), and the dewatering is done by an air flow and a mechanical pressure field. The mechanical pressure field is generated by a permeable belt. The direction of the air flow is from the permeable belt, to the dewatering fabric.

This sandwich of fabrics form an extended pressure nip over a vacuum roll. The max peak pressure is approximately 40 times lower than a conventional press and there is air flow through the nip.

The sheet is protected and further carried by the molding fabric to the Yankee dryer. Sheet is further dried by Yankee/Hood and dry creped.

Accordingly, a structured sheet like a TAD product is produced, with the same premium quality, but without using the extensive TAD machine. There is 40% less capital investment, less machine equipment, less civil work, simplified building, easier operation, less maintenance and 35% less total consumable cost (energy, clothing, chemicals).

Another big advantage of this solution is that the sheet is formed over a structured fabric, starting with very low consistency, between about 0.15 to 0.35% and the same structured fabric is carrying the fibers protected within its structure from the headbox to the transfer to the Yankee dryer. Against the Yankee dryer, only the fibers at the knuckle area of the molding fabric will be pressed, and the protected fibers, within the body of the structured fabric, remain unpressed for quality. The objective is to fill the valleys of the structured fabric with the maximum amount of fibers, because this will be the mass of unpressed fibers which will give the final premium paper quality.

Since the produced sheet is already structured, there is no need to further emboss the sheet going through an expensive converting line to press the micro and macro structures into the sheet. By pressing the structure into the dry sheet, in a converting line, the sheet is compacted, thus the quality, bulk, volume and absorbency capacity is reduced.

Still further, the fabric is preferably made from, but are not limited to mono filament yarns, synthetic or polyester mono filament yarns, twisted mono filament yarns, twisted synthetic or twisted polyester or twisted polyamide mono filament yarns, twisted multi-filament yarns, twisted synthetic or twisted polyester multi-filament yarns, core and sheath, non-plastic materials, co-polymer materials, and others. Various yarn profiles can be employed, including but not limited to yarns having a circular cross sectional shape with one or more diameters, or other cross sectional shapes, for example, non-round cross sectional shapes such as oval, or a polygonal cross sectional shapes, for example diamond, square, pentagonal, hexagonal, septagonal, octagonal, and so forth, or any other shape that the yarns may be fabricated.

Materials used to make the base fabric can be from, but not limited to, polyethylenepterathalate (PET), polyamides (PA), polyethylene naphthalate (PEN), polybutylene terephthalate (PBT) and polyetheretherketone (PEEK). Likewise, the fabric can be made from one or more materials.

The preferred polymeric material to be deposited is at least one of a silicone and a polyurethane. By way of example, the silicone can be any RTV-type two-component heat curable material. Other possible polymeric materials, selectable based on the application, include, but are not limited to, acrylics, epoxy resins, silicones, polyurethanes—such as thermoplastic, thermoset, and two component polyurethanes, hydrosols, polyolefins—such as ABS, PS, PC, PET, PPS, PEEK, PA, EVA, PE, HDPE, LDPE, LLDPE, PP, PTFE, and PVC, UV curables, rubbers—both natural and synthetic, nanopolymers/technology, carbon fullerenes, dendrimers, polymers loaded with carbon or metals, electrically conducting polymers and semi-conductors, liquid crystal polymers, hot melts, polymers that are sensitive to pressure, light and temperature, reactive polymers and living polymers.

When cured, the polymeric material has a shore A hardness of approximately 3 to approximately 80, depending on the material used and the predetermined application.

The polymer material added to the fabric can be deposited in a random pattern, a pseudo-random pattern, a predetermined pattern, or any combination of the three to form a pattern or motif on the final tissue paper. In the preferred embodiment, the polymeric material is delivered to the fabric either through a screen or from a bank of small bore tubes (needle application) set at the predetermined distance above the fabric.

When the screen method is used, the polymeric material is delivered through the screen by a blade that is in contact with the inside face of the screen. In this manner the print height is determined by the thickness of the screen wall.

For the screen application, to control the flow of the polymeric material into the fabric, the viscosity of the polymeric material is less than 40,000 centipoise cP. For small bore needle applications, the viscosity of the polymeric material is less than 50,000 centipoise cP.

The viscosity of the polymeric material is selected to control the amount of penetration of the polymeric material into the fabric. For this invention, penetration is between about 10% and about 100%. The amount of penetration into the fabric is a function of the fabric and the the use of the fabric. For general applications, the preferred penetration is approximately 40%-60%. When a fine mesh fabric is used, the preferred penetration can be up to 100%.

Height of the polymeric material above the surface of the paper side of the fabric is variable depending on the method of application and the desires of the application. For example, when screening the polymeric material onto the fabric, the polymer material has a height above the surface of the fabric of about 0.01 mm to about 1.0 mm, preferably about 0.05 mm. When used for embossing type applications, for example through air drying (TAD), the height above the surface of the fabric is about 0.1 mm to about 2.0 mm, preferably about 0.1 mm to about 1.0 mm, most preferably about 0.05 mm. For small bore needle applications, the height of the polymeric material can be up to 3 mm.

Permeability range of the fabric with the applied pattern/design is approximately 50 cfm to approximately 1200 cfm, preferably in the range of approximately 200 cfm to approximately 900 cfm, and most preferably approximately 300 cfm to approximately 800 cfm.

It is also understood that there are no limitations to the paper grades or former types where this invention can be applied.

These and other features and advantages of this invention are described in or are apparent from the following detailed description of the preferred embodiments.

### BRIEF DESCRIPTION OF THE DRAWINGS

The preferred embodiments of the present inventions is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is a schematic of an advanced dewatering system;

FIG. 2 is a perspective view of a forming fabric with an extended surface according to the present invention;

FIG. 3 is a top view of a forming fabric with an extended surface according to the present invention; and

FIG. 4 is a cross-section along A-A of the forming fabric of FIG. 3.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

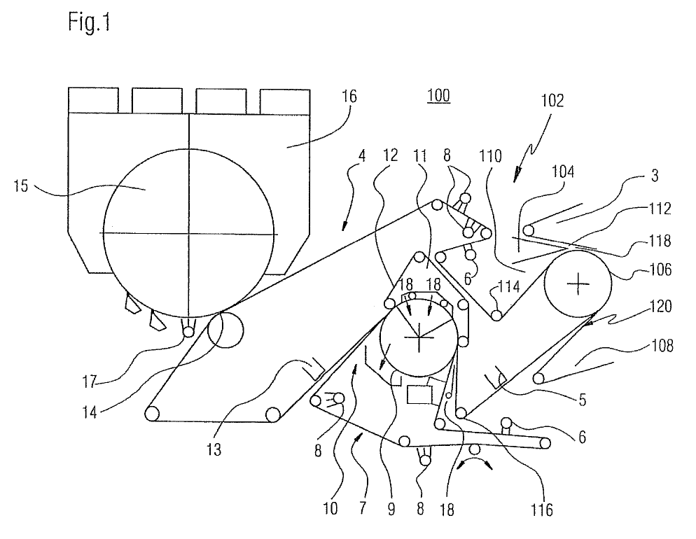

FIG. 1 is a schematic of an advanced dewatering system 100. The forming area 102 is in the initial dewatering area having a head box 104, a forming roll 106, a forming fabric 108 and a molding fabric 110. More specifically, the forming roll 106 has two continuous rotating dewatering belts 108, 110 that converge, forming a stock entry gap 112.

The pulp suspension is introduced into the stock entry gap 112 by the headbox 104.

The molding belt 110 is shown as an inner belt that comes into contact with the forming roll 106. The forming fabric 108 is an outer belt. The pulp suspension is delivered by the headbox 104 into the stock entry gap 112 between the two dewatering belts 108, 110. The inner belt, or molding fabric 110 coming from below is conducted over a guide roll 114 past the headbox 104 to the forming roll 106 and from there it is conducted back again over another guide roll 116.

The forming fabric 108 and molding fabric 110 converge at a convergence location 118 near the stock entry gap 112. The two fabrics 108, 110 squeeze the pulp suspension to form a paper web. The two fabrics 108, 110 separate from each other at a separating location 120 near the forming roll 106.

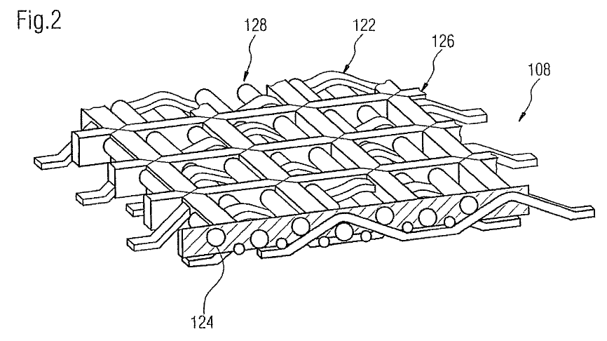

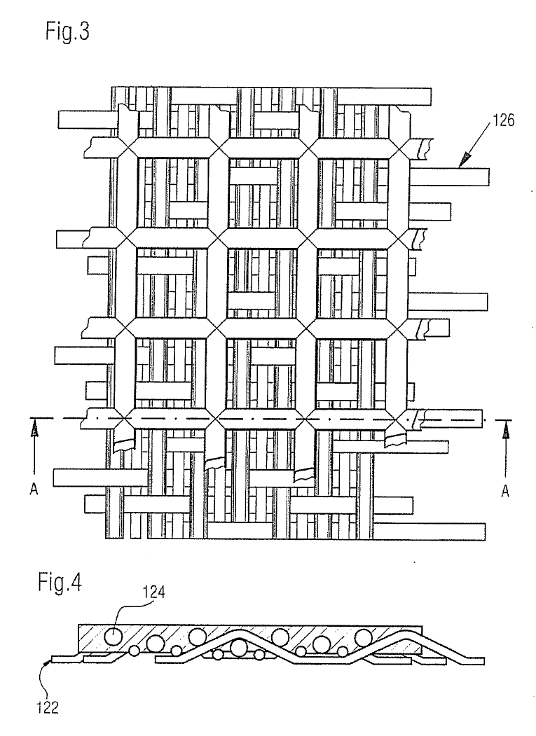

FIGS. 2-4 show the forming fabric 108. A series of warp yarns 122 and weft yarns 124 are woven in a predetermined weave pattern.

The yarn materials include, but are not limited to mono filament yarns, synthetic or polyester mono filament yarns, twisted mono filament yarns, twisted synthetic or twisted polyester or twisted polyamide mono filament yarns, twisted multi-filament yarns, twisted synthetic or twisted polyester multi-filament yarns, and others. Various yarn profiles can be employed, including but not limited to yarns having a circular cross sectional shape with one or more diameters, or other cross sectional shapes, for example, non-round cross sectional shapes such as oval, or a polygonal cross sectional shapes, for example diamond, square, pentagonal, hexagonal, septagonal, octagonal, and so forth, or any other shape that the yarns may be fabricated into.

Materials used to make the base fabric can be from, but not limited to, polyethylenepterathalate (PET), polyamides (PA), polyethylene naphthalate (PEN), polybutylene terephthalate (PBT) and polyetheretherketone (PEEK). Likewise, the fabric can be made from one or more materials.

What results is a forming fabric 108 having a paper side and a wear side. On the paper side of the forming fabric 108, a polymer is applied that forms a polymeric lattice 126. The preferred polymeric material to be deposited is at least one of a silicone and a polyurethane. By way of example, the silicone can be any RTV-type two-component heat curable material. Other possible polymeric materials, selectable based on the application, include, but are not limited to, acrylics, epoxy resins, silicones, polyurethanes—such as thermoplastic, thermoset, and two component polyurethanes, hydrosols, polyolefins—such as ABS, PS, PC, PET, PPS, PEEK, PA, EVA, PE, HDPE, LDPE, LLDPE, PP, PTFE, and PVC, UV curables, rubbers—both natural and synthetic, nanopolymers/technology, carbon fullerenes, dendrimers, polymers loaded with carbon or metals, electrically conducting polymers and semi-conductors, liquid crystal polymers, hot melts, polymers that are sensitive to pressure, light and temperature, reactive polymers and living polymers.

The polymer material added to the fabric 108 can be deposited in a random pattern, a pseudo-random pattern, a predetermined pattern, or any combination of the three to form a pattern or motif on the final tissue paper. In the preferred embodiment, the polymeric material is delivered to the fabric either through a screen or from a bank of small bore tubes (needle application) set at the predetermined distance above the fabric 108.

When the screen method is used, the polymeric material is delivered through the screen by a blade that is in contact with the inside face of the screen. In this manner the polymer height L above the fabric surface 128 is determined by the thickness of the screen wall.

For the screen application, to control the flow of the polymeric material into the fabric, the viscosity of the polymeric material is less than 40,000 centipoise cP. For small bore needle applications, the viscosity of the polymeric material is less than 50,000 centipoise cP.

The viscosity of the polymeric material is selected to control the amount of penetration of the polymeric material into the fabric 108. For this invention, penetration is between about 10% and about 100%. The amount of penetration into the fabric is a function of the fabric and the use of the fabric. For general applications, the preferred penetration is approximately 40%-60%. When a fine mesh fabric is used, the preferred penetration can be up to 100%.

Height of the polymeric material L above the surface 128 of the paper side of the fabric 108 is variable depending on the method of application and the desires of the application. For example, when screening the polymeric material onto the fabric 108, the polymer material has a height L above the surface 128 of the fabric 108 of about 0.01 mm to about 1.0 mm, preferably about 0.05 mm. When used for embossing type applications, for example through air drying (TAD), the height L above the surface of the fabric is about 0.1 mm to about 2.0 mm, preferably about 0.1 mm to about 1.0 mm, most preferably about 0.05 mm. For small bore needle applications, the height L of the polymeric material can be up to 3 mm.

The polymeric lattice 126 of the preferred embodiment extends above the surface 128 of the forming fabric 108 by approximately 0.1 mm.

The polymer material added to the fabric 108 can be deposited in a random pattern, a pseudo-random pattern, a predetermined pattern, or any combination of the three to form a pattern or motif on the final tissue paper. That is, rather than a lattice as depicted, the deposition can form a pattern such as a logo, or other non-continuous pattern.

Width and length of the polymeric lattice 126 can vary, but can range from approximately 0.1 mm to approximately 2 mm, preferably 0.5 mm to 1.0 mm, and more preferably 0.7 mm to

When cured, the polymeric material has a shore A hardness of approximately 3 to approximately 80, depending on the material used and the predetermined application.

Permeability range of the fabric 108 with the applied pattern/design is approximately 50 cfm to approximately 1200 cfm, preferably in the range of approximately 200 cfm to approximately 900 cfm, and most preferably approximately 300 cfm to approximately 800 cfm.

While the present invention has been particularly shown and described with reference to the foregoing preferred embodiments, those skilled in the art will understand that many variations may be made therein without departing from the spirit and scope of the invention as defined in the following claims. This description of the invention should be understood to include all novel and non-obvious combinations of elements described herein, and claims may be presented in this or a later application to any novel and non-obvious combination of these elements. The foregoing embodiments are illustrative, and no single feature or element is essential to all possible combinations that may be claimed in this or a later application. Where the claims recite “a” or “a first” element or the equivalent thereof, such claims should be understood to include incorporation of one or more such elements, neither requiring nor excluding two or more such elements.

What is claimed as new and desired to be protected by Letters Patent of the United States is:

1. A fabric for papermaking comprising:
a woven fabric having a paper side and a roll side, the paper side having a paper side surface and the roll side having a roll side surface; and
a polymer material deposit that extends above the paper side surface;
wherein the polymer material deposit has at least one of a random pattern, a random motif, a pseudo-random pattern, a pseudo-random motif, a predetermined pattern, and a predetermined motif.

2. The fabric for papermaking of claim 1, wherein the polymer material deposit is one of a lattice structure and a logo.

3. The fabric for papermaking of claim 1, wherein the polymer material is at least one of an RTV-type material, an RTV-type heat curable material, an acrylic, an epoxy resin, a silicone, a polyurethane, a hydrosol, a polyolefin, UV curables, a natural rubber, a synthetic rubber, nanopolymers, carbon fullerenes, dendrimers, polymers loaded with carbon, polymers loaded with metals, electrically conducting polymers, semi-conductors, liquid crystal polymers, hot melts, polymers that are sensitive to pressure, polymers that are sensitive to light, polymers that are sensitive to temperature, reactive polymers and living polymers.

4. The fabric for papermaking of claim 3, wherein the polyurethane is at least one of a thermoplastic, thermoset, and two component polyurethanes.

5. The fabric for papermaking of claim 3, wherein the polyolefin is at least one of ABS, PS, PC, PET, PPS, PEEK, PA, EVA, PE, HDPE, LDPE, LLDPE, PP, PTFE, and PVC.

6. The fabric for papermaking of claim 1, wherein the polymer material deposit has a shore A hardness of approximately 3 to approximately 80.

7. The fabric for papermaking of claim 1, wherein the polymeric material is delivered to the fabric by at least one of screen printing and from a bank of small bore tubes.

8. The fabric for papermaking of claim 1, wherein the polymeric material is delivered to the fabric by screen printing and wherein the viscosity of the polymeric material is less than 40,000 centipoise.

9. The fabric for papermaking of claim 1, wherein the polymeric material is delivered to the fabric by small bore needle application and wherein the viscosity of the polymeric material is less than 50,000 centipoise.

10. The fabric for papermaking of claim 1, wherein the polymeric material penetrates into the fabric at a predetermined amount.

11. The fabric for papermaking of claim 1, wherein the polymeric material penetrates into the fabric between about 10% and about 100%.

12. The fabric for papermaking of claim 1, wherein the polymeric material penetrates into the fabric between about 40% and about 60%.

13. The fabric for papermaking of claim 1, wherein the fabric is a fine mesh fabric.

14. The fabric for papermaking of claim 1, wherein the fabric is a fine mesh fabric and polymeric material penetrates into the fabric up to 100%.

15. The fabric for papermaking of claim 1, wherein the height of the polymeric material above the surface of the paper side of the fabric of between about 0.01 mm to about 3.0 mm.

16. The fabric for papermaking of claim 1, wherein the height of the polymeric material above the surface of the paper side of the fabric of between about 0.01 mm to about 1.0 mm.

17. The fabric for papermaking of claim 1, wherein the height of the polymeric material above the surface of the paper side of the fabric is about 0.05 mm.

18. The fabric for papermaking of claim 1, wherein the permeability of the fabric with the deposited polymeric material is between approximately 50 cfm and approximately 1,200 cfm.

19. The fabric for papermaking of claim 1, wherein the permeability of the fabric with the deposited polymeric material is between approximately 200 cfm and approximately 900 cfm.

20. The fabric for papermaking of claim 1, wherein the permeability of the fabric with the deposited polymeric material is between approximately 300 cfm and approximately 800 cfm.

21. The fabric for papermaking of claim 1, wherein the fabric is used on an advanced dewatering system.

22. A fabric for an advanced dewatering system comprising:
a woven fabric having a paper side and a roll side, the paper side having a paper side surface and the roll side having a roll side surface; and
a polymer material deposit that extends above the paper side surface;
wherein the polymer material deposit has at least one of a random pattern, a random motif, a pseudo-random pattern, a pseudo-random motif, a predetermined pattern, and a predetermined motif.
